(19) United States
(12) Patent Application Publication
(10) Pub. No.: US 2009/0093559 A1
(43) Pub. Date: Apr. 9, 2009

(54) Absorbent and Antibacterial Polystyrene Paper (PSP) Sheet, Method for Producing Thereof and Tray Using the Same

(75) Inventor: Bong-Soo Han, Chungcheongbuk-do (KR)

Correspondence Address: LEVINE & MANDELBAUM, 222 Bloomingdale Road, Suite 203, WHITE PLAINS, NY, 10605, US

(73) Assignee: E TECH CO., LTD., Chungcheongbuk-do (KR)

(21) Appl. No.: 11/868,559

(22) Filed: Oct. 8, 2007

(51) Int. Cl. C08K 5/36; B29C 47/00; C08K 5/10; C08K 5/16

(52) U.S. Cl. 521/89; 264/211; 521/94; 521/97

(57) ABSTRACT

Disclosed are an absorbent and antibacterial polystyrene paper, a method for producing thereof, and an absorbent and antibacterial tray using the same. The absorbent and antibacterial polystyrene paper according to the present invention may be useful to absorb into a paper liquids, such as blood, moisture and the like, which is generated from foods in packing the foods such as meats, fishes, etc., by adding an antistatic agent to polystyrene raw materials and foaming the resultant mixture to produce absorbent and antibacterial polystyrene paper and tray, wherein a plurality of absorption holes are formed on one surface thereof. Here, the absorbent and antibacterial polystyrene paper according to the present invention is produced by mixing, foaming and extrusion-melting 91 to 95% by weight of polystyrene, 2 to 4% by weight of a nucleating material master batch and 3 to 5% by weight of an antistatic agent master batch, wherein a plurality of absorption holes are formed on a surface of a molded sheet.

### BACKGROUND OF THE INVENTION

The present invention relates to an absorbent and antibacterial polystyrene paper, a method for producing thereof, and an absorbent and antibacterial tray using the same, and more particularly to an absorbent and antibacterial polystyrene paper capable of absorbing liquids, such as blood, moisture and the like into a paper, which is generated from foods in packing the foods such as meats, fishes, etc., by adding an antistatic agent to polystyrene raw materials and foaming the resultant mixture to produce absorbent and antibacterial polystyrene paper and tray, a plurality of absorption holes being formed on one surface thereof, a method for producing thereof, and an absorbent and antibacterial tray using the same.

As a representative thermoplastic resin, polystyrene is a polymer material obtained by polymerizing a styrene monomer. In recent, styrene resin molded products are widely used in various fields of daily necessities, kitchen utensils, toys, radios, VTR, beverage containers and food-packing trays. Among them, expandable polystyrene is mainly used for food-packing containers such as cup ramen containers, fish supports, meat supports, fruit supports and disposable lunch box containers.

The expandable polystyrene is referred to as polystyrene obtained by mixing a foaming agent, such as propane, butane and pentane, with polystyrene. The expandable polystyrene may be used by itself, or used after it is previously foamed. In this case, the expandable polystyrene may be put into a suitable mold and expanded 5 to 25 times while heating, thereby producing a light and strong foaming molded product.

Meanwhile, the expandable polystyrene may be processed into a shape of sheet using an extruder. At this time the molded sheet is referred to as a polystyrene paper. Generally, the expandable polystyrene used for food container is commercially available in the form of a polystyrene paper.

And, the expandable polystyrene tray is light-weight when compared to trays made of other materials since the polystyrene is foamed to reduce the weight of the polystyrene tray and only a trace of petroleum is advantageously used as a raw material. The expandable polystyrene tray emerged over Japan in 1962, and then has been widely used at home together with the advent of a self-service selling system called a free package system where foods are sold with being previously packaged in a tray.

That is to say, the tray is used when foods are sold in department stores and the like, and it is molded into a certain frame by pressing the plastic paper with a press under a vacuum condition so that it can have a structure of a container with a bottom surface and side surfaces. Therefore, the tray has problems that a value of packaged foods is damaged due to the presence of liquids such as bloods, moisture and the like generated from meats, fishes and the like in packaging the meats, the fishes and the like, and freshness degree of foods is also deteriorated since microorganisms propagate easily in the foods.

### SUMMARY OF THE INVENTION

Accordingly, the present invention is designed to solve the general problems of the prior art that a paper and a food-packing tray have, and therefore it is an object of the present invention to provide an absorbent and antibacterial polystyrene paper capable of enhancing a value of foods, and also maintaining freshness degree of the foods for an extended time and extending its storage duration since it is produced by adding an antistatic agent to a polystyrene raw material, foaming the resultant mixture to form a plurality of absorption holes on a surface thereof, and therefore liquids such as blood or moisture generated form meats, fishes and the like flow in an open cell through absorption holes when the foods is packaged with a paper or a tray, a method for producing thereof and an absorbent and antibacterial tray using the same.

In order to accomplish the above object, one embodiment of the present invention provides a method for producing an absorbent and antibacterial polystyrene paper, the method including: mixing 2 to 4% by weight of a nucleating material master batch and 3 to 5% by weight of an antistatic agent master batch with 91 to 95% by weight of polystyrene; foaming the resultant mixture by adding a foaming agent to the resultant mixture; and extrusion-melting the resultant foamed product and molding it into a sheet, a plurality of absorption holes being formed on a surface of the sheet.

And, the antistatic agent master batch may be prepared by dispersing 2 to 10% by weight of an antistatic agent in 90 to 98% by weight of polystyrene, and the antistatic agent may be selected from the group consisting of quaternary ammonium compounds, epoxidized amine, fatty acid ester and sulfur-oxidized wax.

And, the absorbent and antibacterial polystyrene paper may be produced by mixing, foaming and extrusion-melting 91 to 95% by weight of polystyrene, 2 to 4% by weight of a nucleating material master batch and 3 to 5% by weight of an antistatic agent master batch, wherein a plurality of absorption holes is formed on a surface of a molded sheet.

And, the absorbent and antibacterial tray may be produced by molding the absorbent and antibacterial polystyrene paper.

As described above, the absorbent and antibacterial polystyrene paper, the method for producing thereof and the absorbent and antibacterial tray using the same according to the present invention may useful to enhance a value of foods, as well as to maintain freshness degree of the foods for an extended time and extend its storage duration since it is produced by adding an antistatic agent to a polystyrene raw material, foaming the resultant mixture and forming a plurality of absorption holes on a surface thereof, and therefore liquids such as blood or moisture generated form meats, fishes and the like flow in an open cell through absorption holes when the foods is packaged with a paper or a tray.

Also, the absorbent and antibacterial polystyrene paper, the method for producing thereof and the absorbent and antibacterial tray using the same according to the present invention may be useful to suppress propagation of microorganisms since the paper and tray further includes an antibacterial master batch.

### DESCRIPTION OF THE PREFERRED EMBODIMENT

Hereinafter, preferred embodiment of the present invention will be described in detail.

This is a step of mixing 2 to 4% by weight of a nucleating material master batch and 3 to 5% by weight of an antistatic agent master batch with 91 to 95% by weight of polystyrene,

As the first step, a nucleating material master batch and an antistatic agent master batch are mixed with polystyrene.

At this time, the polystyrene may be commonly used if it is produced in the form of pallet, but the present invention is not particularly limited thereto. Accordingly, the polystyrene may be used without any of particular limitations, and commercially available polystyrenes may be also used herein. Hereinafter, the polystyrene used in the present invention is used in the form of pallet, unless otherwise stated herein.

And, the polystyrene includes general polystyrene (GPPS) and synthetic rubber component-reinforced impact-resistant polystyrene (HIPS), but it is preferred to use the general polystyrene (GPPS) in the present invention.

The master batch refers to a mixture in which respective active ingredients are mixed with a synthetic resin at a high concentration for the purpose of the uniform dispersion of active ingredients to be added together with polystyrene, and the nucleating material means a general processing additive used to process a desired shape of a synthetic resin, and the processing additive is also used as the nucleating material of the present invention.

A master batch obtained by mixing 2 to 10% by weight of a nucleating material with 90 to 98% by weight of polystyrene is used as the nucleating material master batch according to the present invention. In this case, if the content of the nucleating material is less than 2% by weight, the functions of the nucleating material are low, whereas the components in the nucleating material master batch are not easily dispersed if the content of the nucleating material exceeds 10% by weight.

Also, raw materials in the nucleating material master batch having a size of 800 meshes are used to help the formation into open cells.

The antistatic agent master batch is also previously produced by mixing an antistatic agent with polystyrene at a high concentration for the uniform dispersion of the antistatic agent.

The antistatic agent is an adhesive that functions to reduce or get rid of static electricity, which is generated in a surface of a product, by adding it to plastics or treating the surface of the product with it.

The above-mentioned method, which is used to improve electrostaticity caused by the above-mentioned static electricity, includes a method where hydrophilic property is introduced into a product by chemically treating a surface of the product; a method for grafting a monomer having hydrophilic property; a method for adding a good conductive material such metal powder, etc., but the method using the antistatic agent is the most widely used due to the difficulty in its use and the poor productivity.

In the past, the antistatic agent is used to prevent electrostatic sparks that cause explosions of high-concentration flammable gases, or to get rid of uneasiness when products piled high one over another are transferred into another site for additional handlings, or to prevent heaping of dust in grooves of a recorder by static electricity, but it is recently used to prevent damages to the beauty of a plastic container, the damages being caused when the dusts are piled on the plastic container.

In the present invention, the absorbent paper and tray may, however, be produced by dispersing the antistatic agent in a raw material and foaming the antistatic agent and the raw material together without surface-treating the raw material with the antistatic agent having the above-mentioned functions, wherein the absorbent paper and tray are produced to have an open-cell shape other than the conventional closed-cell shape, as well as to prevent the generation of static electricity. This is why a surfactant in the antistatic agent serves as a hydrophilic monomer.

That is to say, the antistatic agent of the present invention is applied to a bubble surface of a foamed product to have miscibility with certain liquids or fluids to be absorbed into the bubble surface and further impart hydrophilic property or hydrophobic property to the foamed product, thereby maximizing its absorbance in the cells, and it is preferred to use one antistatic agent selected from the group consisting of quarternary ammonium compounds, epoxidized amine, fatty acid ester and sulfur-oxidized wax.

And, the antistatic agent master batch is preferably produced by dispersing 2 to 10% by weight of the antistatic agent in 90 to 98% by weight of polystyrene, but the present invention is not particularly limited thereto. However, the antistatic agent plays its poor roles if the content of the mixed antistatic agent is too low, whereas the components in the master batch are sufficiently dispersed if the content of the mixed antistatic agent is too high.

Also, the mixed ratio of the polystyrene, the nucleating material master batch and the antistatic agent master batch is obtained by mixing 2 to 4% by weight of the nucleating material master batch and 3 to 5% by weight of the antistatic agent master batch with 91 to 95% by weight of the polystyrene. In this case, if the content of the mixed nucleating material master batch is less than 2% by weight, normal roles of the nucleating material is impossible, whereas the size of the cells is reduced due to the presence of its excessive amount if the content of the mixed nucleating material master batch exceeds 4% by weight. Also, insufficient miscibility is given to a foamed product due to the presence of its small amount if the content of the antistatic agent master batch is less than 3% by weight, whereas the mixed nucleating material master batch is present in an excessive amount if the content of the antistatic agent master batch exceeds 5% by weight.

As described above, when the mixing of the raw material is completed, a foaming agent is added to the mixture, and the mixture is then foamed. At this time, commercially available foaming agents may be usually used without any of limitation, but the present invention is not particularly limited thereto. However, it is preferred to use one foaming agent selected from the group consisting of liquid propane gas, Freon gas, butane gas and carbon dioxide.

Also, the introduced foaming agent is preferably used in an amount of 1 to 6% by weight, based on the total weight of the raw material, but the present invention is not particularly limited thereto. And, at least one lower alcohol may be used together with the foaming agent, and examples of the lower alcohol, which may be used herein, includes methanol, ethanol, propanol, isopropanol, butanol, pentanol, etc.

At this time, the foaming process should be carried out at a slightly higher temperature than the conventional foaming temperature to form sufficient numbers of open cells. In this case, the foamed product should not be broken due to the extremely increased temperature.

If the foaming process is completed as described above, the foamed product is cooled and extruded into a shape of sheet. At this time, the cooling and extruding conditions are not particularly limited herein, but the extrusion process is carried out in a slightly higher temperature than the conventional operating temperature of the extruder to prevent a surfactant in the antistatic agent from being quenched. This is why the foamed product of the present invention has an open-cell structure other than the conventional closed-cell structure, and therefore the cells in the foamed product may be reduced in size or broken when the foamed product is cooled quickly. Therefore, it is preferred to increase a temperature of dies in the extruder from a conventional temperature of 140° C. to about 150° C. and to increase a temperature of a secondary side cylinder from a conventional temperature of 150° C. to about 185° C.

Also, a plurality of absorption holes with a depth of 2.6 mm and a diameter of 2 mm are formed in a surface of a paper to be extruded during the extrusion process, and therefore they functions as an absorption portion for liquids, and also as a passage between the open cells by providing an absorption path for liquids or fluids that are in contact with the surfaces of the absorption holes.

For the method for forming the absorption holes, one side roller among a coating roller and a pressure roller in the conventional extruder may be installed with a shape where a plurality of absorption holes may be formed in a surface of a paper, or it is possible to install a roller for forming respective absorption holes as shown in FIG. 1. However, the above-mentioned method may be used without any of particular limitations, and therefore all methods may be possible only if the methods are used for forming a plurality of absorption holes in a surface of a paper. That is to say, it goes without saying that absorption holes may be formed with separate tools, or through other methods if a plurality of the absorption holes may be formed in the paper surface.

The absorption holes of the present invention function as a connection path for open cells since the absorption holes are passed through, and therefore the absorption holes function to allow liquids that are in contact with the paper surface to flow in open cells through the absorption holes, and also function as an absorption portion for the liquid to enhance an absorption rate of the paper as well as absorbance of the paper.

And, it is desirable to form the absorption holes in only one side of the paper, as well as the entire surfaces of the paper, and the paper may be passed through, and the absorption holes may be formed only in a surface of the penetrated paper. Also, there is no particular limitation on the shapes or numbers of the absorption holes.

Also, it is reasonable that the polystyrene paper that is extruded into a shape of sheet may be produced through a fullroll step, a coating step and a winding step, all of which have been widely known in the art.

As another embodiment, it is possible to further mix an antibacterial master batch to further suppress propagation of microorganisms in the mixing step. The antibacterial master batch refers to a mixture in which a high concentration of an antibacterial active material is dispersed in an additional polystyrene resin so that the antibacterial active material can be uniformly dispersed in the polystyrene paper. All kinds of antimicrobial agents known in the art may be used as the antibacterial active material, but it is preferred to use an antibacterial inorganic ceramic composition composed of aluminum hydroxide, silicon chloride and antibacterial metal ions. And, silver (Ag) is preferably used as the antibacterial metal ions.

The antibacterial master batch may be produced by mixing 10˜40% by weight of an inorganic antimicrobial agent with 60 to 90% by weight of polystyrene.

And, the mixed antibacterial master batch is preferably added in a ratio of 5 to 10 part by weight, based on the 100 part by weight of the polystyrene, the nucleating material master batch and the antistatic agent master batch.

And, since the absorbent and antibacterial polystyrene paper according to the above-mentioned method is produced by mixing, foaming and extrusion-melting 85 to 95% by weight of polystyrene, 2 to 4% by weight of a nucleating material master batch and 3 to 4% by weight of an antistatic agent master batch, wherein a plurality of absorption holes is formed on a surface of a molded sheet. Therefore, description of the absorbent and antibacterial polystyrene paper is omitted because the absorbent and antibacterial polystyrene paper is previously described in detail.

Also, It goes without saying that the paper may further include an antibacterial master batch.

And, the above-mentioned absorbent and antibacterial polystyrene paper may be molded into a food-packaging tray, and therefore bloods and moisture generated from meats and fishes are absorbed into the food-packing tray when the meats, the fishes and the like are packaged.

Methods known in the art may be used as the methods for forming a tray. For example, the tray may be produced using various methods, including a heat molding method or a vacuum molding method in which a paper is passed through a heater zone and molded using a mold, an ejection molding method in which a melted resin is injected from an injection machine and molded in a mold, and a compression molding method in which a resin is put into a mold, heated and compressed.

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A method for producing an absorbent and antibacterial polystyrene paper, the method comprising:
mixing 2 to 4% by weight of a nucleating material master batch and 3 to 5% by weight of an antistatic agent master batch with 91 to 95% by weight of polystyrene;
foaming the resultant mixture by adding a foaming agent to the resultant mixture; and
extrusion-melting the resultant foamed product and molding it into a sheet, a plurality of absorption holes being formed on a surface of the sheet,
wherein the antistatic agent master batch is prepared by dispersing 2 to 10% by weight of an antistatic agent in 90 to 98% by weight of polystyrene, and the antistatic agent is selected from the group consisting of quaternary ammonium compounds, epoxidized amine, fatty acid ester and sulfur-oxidized wax.

2. The method for producing an absorbent and antibacterial polystyrene paper according to claim 1, wherein the antibacterial master batch is additionally added in the mixing step.

3. An absorbent and antibacterial polystyrene paper that is produced by mixing, foaming and extrusion-melting 91 to 95% by weight of polystyrene, 2 to 4% by weight of a nucleating material master batch and 3 to 5% by weight of an antistatic agent master batch, a plurality of absorption holes being formed on a surface of a molded sheet,
wherein the antistatic agent master batch is prepared by dispersing 2 to 10% by weight of an antistatic agent in 90 to 98% by weight of polystyrene, and the antistatic agent is selected from the group consisting of quaternary ammonium compounds, epoxidized amine, fatty acid ester and sulfur-oxidized wax.

4. The absorbent and antibacterial polystyrene paper according to claim 3, wherein the antibacterial master batch is additionally added when the nucleating material master batch and the antistatic agent master batch are mixed with the polystyrene.

5. An absorbent and antibacterial tray using the absorbent and antibacterial polystyrene paper, characterized in that it is prepared by molding the absorbent and antibacterial polystyrene paper as defined in claim 3.

6. An absorbent and antibacterial tray using the absorbent and antibacterial polystyrene paper, characterized in that it is prepared by molding the absorbent and antibacterial polystyrene paper as defined in claim 4.
